(19) United States
(12) Patent Application Publication
(10) Pub. No.: US 2024/0151687 A1
(43) Pub. Date: May 9, 2024

(54) SOLUTION DETECTION CIRCUIT AND APPARATUS, DRIVING METHOD AND SOLUTION DETECTION METHOD

(71) Applicant: Shanghai Tianma Microelectronics Co., Ltd., Shanghai (CN)

(72) Inventors: Wei LI, Shanghai (CN); Kaidi ZHANG, Shanghai (CN); Dongli ZHANG, Shanghai (CN); Liying WANG, Shanghai (CN); Baiquan LIN, Shanghai (CN); Juntao PAN, Shanghai (CN)

(73) Assignee: Shanghai Tianma Microelectronics Co., Ltd., Shanghai (CN)

(21) Appl. No.: 18/413,242

(22) Filed: Jan. 16, 2024

(30) Foreign Application Priority Data
Jun. 30, 2023 (CN) 202310801464.1

(51) Int. Cl. G01N 27/414

(52) U.S. Cl. CPC G01N 27/4148

(57) ABSTRACT

Provided are a solution detection circuit and apparatus, a driving method and a solution detection method. The solution detection circuit includes at least one detection unit, the detection unit includes an ion-sensitive field-effect transistor, a first reset switch subunit, a synchronous buck switch subunit, a storage capacitor and an output switch subunit. A threshold voltage of the ion-sensitive field-effect transistor can be directly read.

### CROSS-REFERENCE TO RELATED APPLICATION(S)

This application claims priority to Chinese Patent Application No. 202310801464.1 filed with the China National Intellectual Property Administration (CNIPA) on Jun. 30, 2023, the disclosure of which is incorporated herein by reference in its entirety.

### TECHNICAL FIELD

The present disclosure relates to the technical field of solution detection and, in particular, to a solution detection circuit and apparatus, a driving method and a solution detection method.

### BACKGROUND

An ion-sensitive field-effect transistor (ISFET) is a microelectronic ion-selective sensitive element having dual characteristics of electrochemistry and a transistor. At present, the pH detection or the ion concentration detection of a solution can be achieved through a test of a threshold voltage of the ISFET. However, the threshold voltage of the ISFET cannot be directly read due to the limitation on device structure and circuit characteristics.

### SUMMARY

The present disclosure provides a solution detection circuit and apparatus, a driving method and a solution detection method to directly read a threshold voltage of an ion-sensitive field-effect transistor, thereby improving a solution detection speed.

Embodiments of the present disclosure provide a solution detection circuit. The solution detection circuit includes at least one detection unit, and the detection unit includes an ion-sensitive field-effect transistor, a first reset switch subunit, a synchronous buck switch subunit, a storage capacitor and an output switch subunit.

A first terminal of the first reset switch subunit is connected to a reference voltage, a second terminal of the first reset switch subunit is connected to a gate of the ion-sensitive field-effect transistor, and a third terminal of the first reset switch subunit is connected to a drain of the ion-sensitive field-effect transistor. A first terminal of the synchronous buck switch subunit is connected to the gate of the ion-sensitive field-effect transistor, a second terminal of the synchronous buck switch subunit is connected to the drain of the ion-sensitive field-effect transistor, a third terminal of the synchronous buck switch subunit is connected to a source of the ion-sensitive field-effect transistor, and a fourth terminal of the synchronous buck switch subunit is connected to the ground. A first plate of the storage capacitor is connected to the gate of the ion-sensitive field-effect transistor, and a second plate of the storage capacitor is connected to the ground. A first terminal of the output switch subunit is connected to the drain of the ion-sensitive field-effect transistor. A control terminal of the first reset switch subunit is connected to a first scan signal, a control terminal of the synchronous buck switch subunit is connected to a second scan signal, and a control terminal of the output switch subunit is connected to a third scan signal.

Embodiments of the present disclosure further provide a solution detection apparatus. The solution detection apparatus includes the above-mentioned solution detection circuit.

Embodiments of the present disclosure further provide a method for driving the above-mentioned solution detection circuit. The method for driving the solution detection circuit includes the steps described below.

The first reset switch subunit is turned on to reset a gate voltage and a drain voltage of the ion-sensitive field-effect transistor to the reference voltage and charge the storage capacitor.

The first reset switch subunit is turned off, and the synchronous buck switch subunit is turned on, so that the gate voltage and the drain voltage of the ion-sensitive field-effect transistor drop to the threshold voltage of the ion-sensitive field-effect transistor.

The output switch subunit is turned on to output the threshold voltage through the output switch subunit.

Embodiments of the present disclosure further provide a solution detection method applied to the preceding solution detection circuit. The solution detection method includes the steps described below.

The first reset switch subunit is turned on to reset a gate voltage and a drain voltage of the ion-sensitive field-effect transistor to the reference voltage and charge the storage capacitor.

The first reset switch subunit is turned off, and the synchronous buck switch subunit is turned on, so that the gate voltage and the drain voltage of the ion-sensitive field-effect transistor drop to the threshold voltage of the ion-sensitive field-effect transistor.

The output switch subunit is turned on to output the threshold voltage through the output switch subunit.

A pH value or an ion concentration of a to-be-detected solution is determined according to the threshold voltage.

### BRIEF DESCRIPTION OF DRAWINGS

The drawings here are incorporated in the specification and form part of the specification to illustrate embodiments in accordance with the present disclosure and are intended to explain the principles of the present disclosure together with the description of the drawings.

To illustrate technical schemes in the embodiments of the present disclosure or in the related art more clearly, drawings used in description of the embodiments or the related art will be briefly described below. Apparently, those of ordinary skill in the art may obtain other drawings based on the drawings described below on the premise that no creative work is done.

FIG. 1 is a schematic diagram of a circuit structure of a solution detection circuit according to an embodiment of the present disclosure.

FIG. 2 is a schematic diagram of a circuit structure of a detection unit according to an embodiment of the present disclosure.

FIG. 3 is a diagram illustrating a working timing of a detection unit according to an embodiment of the present disclosure.

FIG. 4 is a schematic diagram of a circuit structure of another detection unit according to an embodiment of the present disclosure.

FIG. 5 is a schematic diagram of a circuit structure of another detection unit according to an embodiment of the present disclosure.

FIG. 6 is a schematic diagram of a circuit structure of another detection unit according to an embodiment of the present disclosure.

FIG. 7 is a schematic diagram of a circuit structure of another detection unit according to an embodiment of the present disclosure.

FIG. 8 is a structure diagram of a detection unit according to an embodiment of the present disclosure.

FIG. 9 is a schematic diagram of a circuit structure of another detection unit according to an embodiment of the present disclosure.

FIG. 10 is a schematic diagram of a circuit structure of another detection unit according to an embodiment of the present disclosure.

FIG. 11 is a curve illustrating a relationship between a gate-source voltage and a drain current of a transistor according to an embodiment of the present disclosure.

FIG. 12 is a schematic diagram of a circuit structure of another detection unit according to an embodiment of the present disclosure.

FIG. 13 is a schematic diagram of a circuit structure of another detection unit according to an embodiment of the present disclosure.

FIG. 14 is a schematic diagram of a circuit structure of another detection unit according to an embodiment of the present disclosure.

FIG. 15 is a structure diagram of another detection unit according to an embodiment of the present disclosure.

FIG. 16 is a schematic diagram of an array structure of a solution detection circuit according to an embodiment of the present disclosure.

FIG. 17 is a schematic diagram of an array structure of another solution detection circuit according to an embodiment of the present disclosure.

FIG. 18 is a schematic diagram of an array structure of another solution detection circuit according to an embodiment of the present disclosure.

FIG. 19 is a schematic diagram of an array structure of another solution detection circuit according to an embodiment of the present disclosure.

### DETAILED DESCRIPTION

To illustrate the purpose, features and advantages of the present disclosure more clearly, the technical schemes of the present disclosure will be further described. It is to be noted that if not in collision, the embodiments and features therein in the present disclosure may be combined with each other.

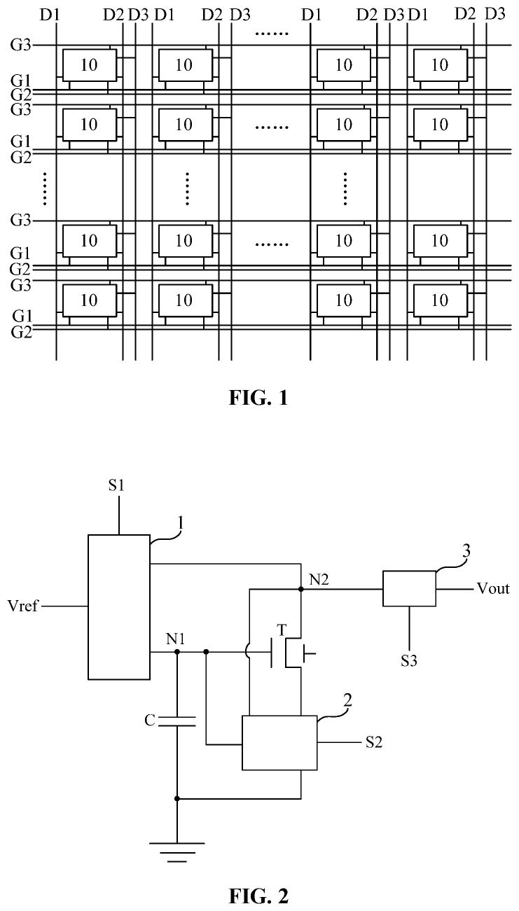

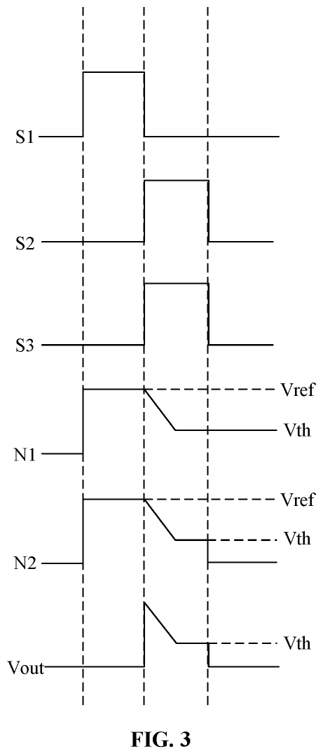

FIG. 1 is a schematic diagram of a circuit structure of a solution detection circuit according to an embodiment of the present disclosure, and FIG. 2 is a schematic diagram of a circuit structure of a detection unit according to an embodiment of the present disclosure. As shown in FIGS. 1 and 2, the solution detection circuit provided in the embodiment of the present disclosure includes at least one detection unit 10 (a plurality of detection units 10 are shown in FIG. 1), and the detection unit 10 includes an ion-sensitive field-effect transistor T, a first reset switch subunit 1, a synchronous buck switch subunit 2, a storage capacitor C and an output switch subunit 3. A first terminal of the first reset switch subunit 1 is connected to a reference voltage Vref, a second terminal of the first reset switch subunit 1 is connected to a gate of the ion-sensitive field-effect transistor T, and a third terminal of the first reset switch subunit 1 is connected to a drain of the ion-sensitive field-effect transistor T. A first terminal of the synchronous buck switch subunit 2 is connected to the gate of the ion-sensitive field-effect transistor T, a second terminal of the synchronous buck switch subunit 2 is connected to the drain of the ion-sensitive field-effect transistor T, a third terminal of the synchronous buck switch subunit 2 is connected to a source of the ion-sensitive field-effect transistor T, and a fourth terminal of the synchronous buck switch subunit 2 is connected to the ground. A first plate of the storage capacitor C is connected to the gate of the ion-sensitive field-effect transistor T, and a second plate of the storage capacitor C is connected to the ground. A first terminal of the output switch subunit 3 is connected to the drain of the ion-sensitive field-effect transistor T. A control terminal of the first reset switch subunit 1 is connected to a first scan signal S1, a control terminal of the synchronous buck switch subunit 2 is connected to a second scan signal S2, and a control terminal of the output switch subunit 3 is connected to a third scan signal S3.

It is to be noted that the ion-sensitive field-effect transistor T involved in the present disclosure has a double-gate structure including a top gate (also known as a floating gate) and a bottom gate (the gate of the ion-sensitive field-effect transistor T in the embodiments of the present disclosure). An ion-sensitive layer is formed on the surface of the top gate, and the ion-sensitive membrane is capable of adsorbing specific ions or molecules. For ions that need to be detected, a corresponding ion-sensitive membrane is disposed. The ion-sensitive field-effect transistor T provided in the embodiments of the present disclosure can be used for the concentration detection of ions such as hydrogen ions or chloride ions, and the principle is as follows: when the ion-sensitive field-effect transistor T is immersed in a to-be-detected solution, an amount of electric charge on the surface of the ion-sensitive layer varies according to a variation in the ion concentration of the solution so that a threshold voltage of the ion-sensitive field-effect transistor T is affected, that is, the threshold voltage of the ion-sensitive field-effect transistor T is affected by the ion concentration of the solution and drifts to the left (decrease) or to the right (increase) in a subthreshold region relative to a reference threshold voltage; a variation amount of the threshold voltage may be obtained, a variation amount of a pH value may be calculated according to a relationship between the variation amount of the threshold voltage and the variation amount of the pH value, and a pH value of the to-be-detected solution may be obtained according to a reference pH value calibrated based on a standard solution. Finally, the ion concentration of the to-be-detected solution may be obtained according to a relationship between the ion concentration and the pH value. In addition, the ion-sensitive field-effect transistor T may be an n-type transistor, and in this case, the threshold voltage of the ion-sensitive field-effect transistor T is affected by the ion concentration of the solution to drift to the left; alternatively, the ion-sensitive field-effect transistor T may be a p-type transistor, and in this case, the threshold voltage of the ion-sensitive field-effect transistor T is affected by the ion concentration of the solution to drift to the right.

In the preceding embodiment, the first scan signal S1 is used for controlling the first reset switch subunit 1 to turn on or off. When the first reset switch subunit 1 is turned on, the first terminal of the first reset switch subunit 1 is connected to the gate of the ion-sensitive field-effect transistor T via the second terminal of the first reset switch subunit 1 while the first terminal of the first reset switch subunit 1 is connected to the drain of the ion-sensitive field-effect transistor T via the third terminal of the first reset switch subunit 1 so that the reference voltage Vref reaches a node N1 and a node N2 via the first reset switch subunit 1, the storage capacitor C is charged and the gate voltage and the drain voltage of the ion-sensitive field-effect transistor T and a voltage of the storage capacitor C are all equal to the reference voltage Vref. The reference voltage Vref enables the ion-sensitive field-effect transistor T to turn on, that is, for the n-type ion-sensitive field-effect transistor, the reference voltage Vref is greater than the threshold voltage of the ion-sensitive field-effect transistor T (the threshold voltage that drifts due to the effect of the ion concentration of the solution), and for the p-type ion-sensitive field-effect transistor, the reference voltage Vref is less than the threshold voltage of the ion-sensitive field-effect transistor T. In this manner, the gate voltage of the ion-sensitive field-effect transistor T can reach the threshold voltage in a subsequent process of discharge of the storage capacitor C, thereby ensuring that the detection unit accurately outputs the threshold voltage and improving the accuracy of the solution detection.

In addition, the second scan signal S2 is used for controlling the synchronous buck switch subunit 2 to turn on or off. When the synchronous buck switch subunit 2 is turned off, the gate and the drain of the ion-sensitive field-effect transistor T are disconnected while the source of the ion-sensitive field-effect transistor T and the ground are disconnected. In this manner, when the first reset switch subunit 1 is turned on, the second scan signal S2 controls the synchronous buck switch subunit 2 to turn off. On the one hand, the gate and the drain of the ion-sensitive field-effect transistor T are disconnected so that the second terminal and the third terminal of the first reset switch subunit 1 can be prevented from shorting in the case where the first reset switch subunit 1 is turned on, thereby avoiding the burnout of the first reset switch subunit 1 due to the internal short circuit. On the other hand, the source of the ion-sensitive field-effect transistor T and the ground are disconnected so that a reference signal source providing the reference signal Vref can be prevented from being connected to the ground via the first reset switch subunit 1, the ion-sensitive field-effect transistor T and the synchronous buck switch subunit 2, that is, the reference signal source is prevented from being shorted, thereby avoiding the burnout of the reference signal source. When the synchronous buck switch subunit 2 is turned on, the gate and the drain of the ion-sensitive field-effect transistor T are connected while the source of the ion-sensitive field-effect transistor T and the ground are connected. In this manner, when the first reset switch subunit 1 is turned off, the second scan signal S2 controls the synchronous buck switch subunit 2 to turn on. In this case, since the gate and the drain of the ion-sensitive field-effect transistor T are connected, the drain voltage and the gate voltage of the ion-sensitive field-effect transistor T are the same all the time. Moreover, the first reset switch subunit 1 is turned off, and the gate voltage of the ion-sensitive field-effect transistor T is no longer held at the reference voltage Vref due to the effect of the discharge of the storage capacitor C, but an absolute value of the gate voltage gradually decreases, and the drain voltage varies with the gate voltage. At the same time, the source of the ion-sensitive field-effect transistor T is connected to the ground, and the synchronous buck switch subunit 2 and the ion-sensitive field-effect transistor T form a discharge path of the storage capacitor C, so that a discharge rate of the storage capacitor C is improved and the gate voltage and the drain voltage of the ion-sensitive field-effect transistor T can quickly reach the threshold voltage, thereby improving solution detection efficiency. When the gate voltage of the ion-sensitive field-effect transistor T reaches the threshold voltage, the ion-sensitive field-effect transistor T is turned off. In this case, the above discharge path is disconnected, and the storage capacitor C slowly discharges. Correspondingly, the gate voltage and the drain voltage of the ion-sensitive field-effect transistor T vary slowly. In this manner, through an analysis on a variation speed of the drain voltage, it is easy to determine when the drain voltage reaches the threshold voltage of the ion-sensitive field-effect transistor T, thereby improving the accuracy of the threshold voltage.

In addition, it is considered that if a detection voltage is always output through the node N2, due to interference of an external signal, the detection voltage drifts, resulting in an error of the threshold voltage. The variation amount of the threshold voltage affected by the ion concentration is very small, and even if the above error is relatively small, the accuracy of the ion concentration detection is significantly reduced. In view of this, the present disclosure provides the output switch subunit 3 for controlling the output of the detection voltage Vout. The third scan signal S3 is used for controlling the output switch subunit 3 to turn on or off. Only when the output switch subunit 3 is controlled to turn on, the detection voltage of the node N2 is output via the output switch subunit 3, and thus the threshold voltage of the ion-sensitive field-effect transistor T is read. In an embodiment, the output switch subunit 3 and the synchronous buck switch subunit 2 may be turned on at the same time, or the output switch subunit 3 may be turned on after the synchronous buck switch subunit 2 is turned on (as long as the threshold voltage can be measured). In this manner, the detection voltage of the node N2 can be prevented from outputting for a long time, and the threshold voltage is effectively prevented from drifting due to the interference of the external signal, thereby improving the accuracy of the threshold voltage and further improving the accuracy of the solution detection.

Based on the preceding embodiment and in conjunction with FIG. 3 (in FIG. 3, turning on each switch subunit at a high level is used as an example, and in other examples, each switch subunit may also be turned on at a low level), a working principle of the detection unit 10 is described as follows: the first scan signal S1 controls the first reset switch subunit 1 to turn on so that both the gate voltage (the voltage of the node N1) and the drain voltage (the voltage of the node N2) of the ion-sensitive field-effect transistor T are reset to the reference voltage Vref while the voltage of the storage capacitor C is charged to the reference voltage Vref, and in this case, the ion-sensitive field-effect transistor is turned on. Then, the first scan signal S1 controls the first reset switch subunit 1 to turn off while the second scan signal S2 controls the synchronous buck switch subunit 2 to turn on and the third scan signal S3 controls the output switch subunit 3 to turn on so that the storage capacitor C continuously discharges and the absolute value of the voltage of the storage capacitor C continuously drops. Under the action of the voltage of the storage capacitor C, the voltage at the node N2 and the voltage at the node N1 are the same and synchronously drop while the output switch subunit 3 outputs the voltage of the node N2, that is, the detection voltage Vout. Before the voltage of the node N1 reaches the threshold voltage of the ion-sensitive field-effect transistor T, the ion-sensitive field-effect transistor T remains the on state. When the voltage of the node N1 reaches the threshold voltage of the ion-sensitive field-effect transistor T, the ion-sensitive field-effect transistor T is turned off, and in this case, the voltage of the node N2 output by the output switch subunit 3 is the threshold voltage Vth of the ion-sensitive field-effect transistor T. In addition, the second scan signal S2 may control the synchronous buck switch subunit 2 to turn off, and the third scan signal S3 controls the output switch subunit 3 to turn off, so that the voltage at the node N2 becomes 0 and the output of the detection voltage Vout is disconnected.

In some embodiments, the first scan signal S1 may be transmitted to the control terminal of the first reset switch subunit 1 via a first scan signal line G1, the second scan signal S2 may be transmitted to the control terminal of the synchronous buck switch subunit 2 via a second scan signal line G2, the third scan signal S3 may be transmitted to the control terminal of the output switch subunit 3 via a third scan signal line G3, the reference voltage may be transmitted to the first terminal of the first reset switch subunit 1 via a reference voltage line D1, a ground signal may be transmitted to the fourth terminal of the synchronous buck switch subunit 2 and the second plate of the storage capacitor C via a ground line D2 so that the fourth terminal of the synchronous buck switch subunit 2 is connected to the ground and the second plate of the storage capacitor C is connected to the ground, an output signal line D3 is connected to the second terminal of the output switch subunit 3, and the detection voltage is output via the output signal line D3.

In the solution detection circuit provided in the embodiments of the present disclosure, both the gate voltage and the drain voltage of the ion-sensitive field-effect transistor are reset to the reference voltage by the first reset switch subunit so that the ion-sensitive field-effect transistor can be turned on while the storage capacitor connected to the gate of the ion-sensitive field-effect transistor is charged; then, the gate and the drain of the ion-sensitive field-effect transistor are connected by the synchronous buck switch subunit so that the gate voltage and the drain voltage of the ion-sensitive field-effect transistor are the same and synchronously decrease in the process of discharge of the storage capacitor; when the gate voltage of the ion-sensitive field-effect transistor drops to the threshold voltage of the ion-sensitive field-effect transistor, the ion-sensitive field-effect transistor is turned off, and the drain voltage of the ion-sensitive field-effect transistor is output by the output switch subunit, thereby directly reading the threshold voltage of the ion-sensitive field-effect transistor. In this manner, through the technical scheme provided in the embodiment of the present disclosure, the threshold voltage of the ion-sensitive field-effect transistor can be directly read, thereby achieving the pH detection or the ion concentration detection of the solution according to the threshold voltage and improving a solution detection speed.

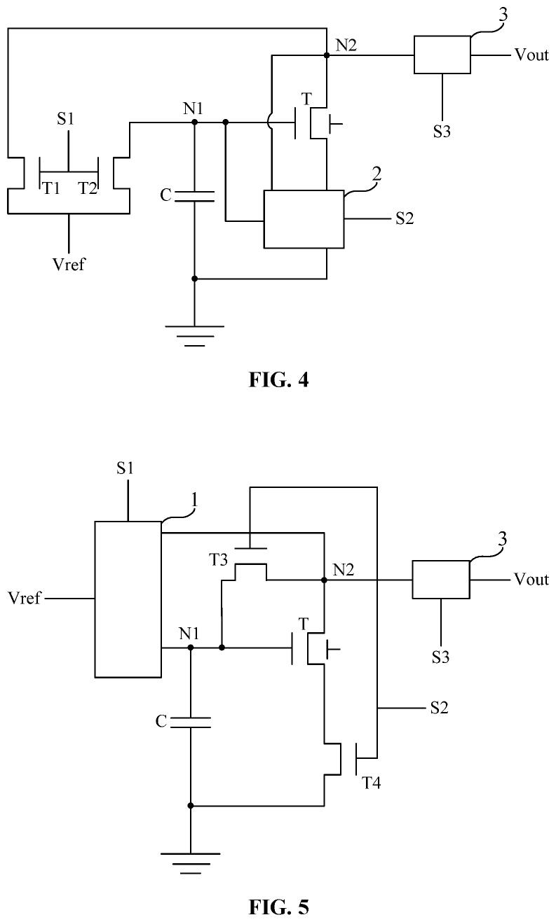

Based on the above technical scheme, in an embodiment, as shown in FIG. 4, the first reset switch subunit includes a first transistor T1 and a second transistor T2, both a gate of the first transistor T1 and a gate of the second transistor T2 are connected to the first scan signal S1, both a first electrode of the first transistor T1 and a first electrode of the second transistor T2 are connected to the reference voltage Vref, a second electrode of the first transistor T1 is connected to the drain of the ion-sensitive field-effect transistor T, and a second electrode of the second transistor T2 is connected to the gate of the ion-sensitive field-effect transistor T. In this manner, when the first scan signal S1 controls the first reset switch subunit to turn on, both the first transistor T1 and the second transistor T2 are turned on, the reference voltage Vref is transmitted to the node N2 via the first transistor T1 while the reference voltage Vref is transmitted to the node N1 via the second transistor T2, the drain voltage and the gate voltage of the ion-sensitive field-effect transistor T are reset to the reference voltage Vref, and the storage capacitor C is charged. In an embodiment, the first transistor T1 and the second transistor T2 may both be N-channel metal oxide semiconductor (NMOS) transistors or P-channel metal oxide semiconductor (PMOS) transistors, and only the first scan signal S1 is opposite in polarity for NMOS transistors and PMOS transistors.

In an embodiment, as shown in FIG. 5, the synchronous buck switch subunit includes a third transistor T3 and a fourth transistor T4, both a gate of the third transistor T3 and a gate of the fourth transistor T4 are connected to the second scan signal S2, a first electrode of the third transistor T3 is connected to the gate of the ion-sensitive field-effect transistor T, a second electrode of the third transistor T3 is connected to the drain of the ion-sensitive field-effect transistor T, a first electrode of the fourth transistor T4 is connected to the source of the ion-sensitive field-effect transistor T, and a second electrode of the fourth transistor T4 is connected to the ground. In this manner, when the second scan signal S2 controls the synchronous buck switch subunit to turn on, both the third transistor T3 and the fourth transistor T4 are turned on, and the third transistor T3 connects the node N1 to the node N2, so that the voltage at the node N1 can be synchronized to the node N2, and the voltage at the node N2 remains consistent with the voltage at the node N1. So when the voltage at the node N1 reaches the threshold voltage of the ion-sensitive field-effect transistor T, the threshold voltage can be output by the output switch subunit 3 via the node N2. In addition, the source of the ion-sensitive field-effect transistor T is connected to the ground via the fourth transistor T4 so that the third transistor T3, the ion-sensitive field-effect transistor T and the fourth transistor T4 constitute a discharge channel of the storage capacitor C, the storage capacitor C quickly discharges before the ion-sensitive field-effect transistor T is turned off and the voltage at the node N1 quickly reaches the threshold voltage of the ion-sensitive field-effect transistor T. In an embodiment, the third transistor T3 and the fourth transistor T4 may both be NMOS transistors or PMOS transistors, and only the second scan signal S2 is opposite in polarity.

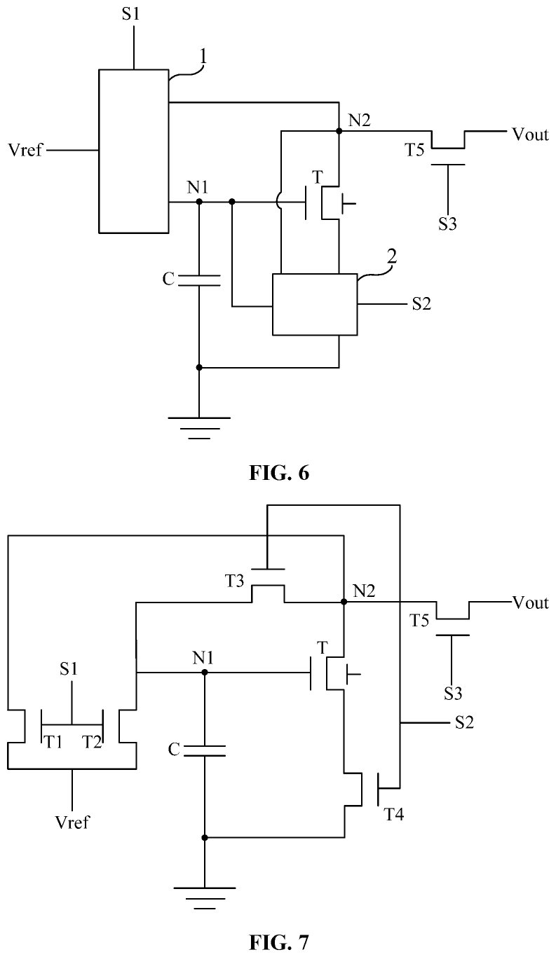

In an embodiment, as shown in FIG. 6, the output switch subunit includes a fifth transistor T5, a first electrode of the fifth transistor T5 is connected to the drain of the ion-sensitive field-effect transistor T, and a gate of the fifth transistor T5 is connected to the third scan signal S3. In this manner, when the third scan signal S3 controls the output switch subunit to turn on, the fifth transistor T5 is turned on, and the voltage at the node N2, that is, the detection voltage Vout, is output via the fifth transistor T5. In an embodiment, the fifth transistor T5 may be an NMOS transistor or a PMOS transistor, and only the third scan signal S3 is opposite in polarity.

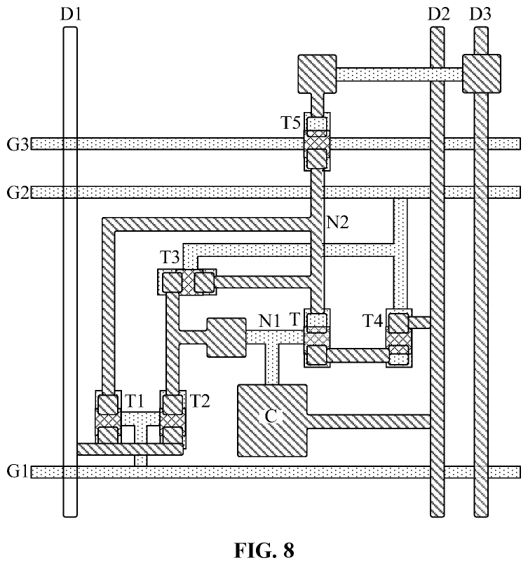

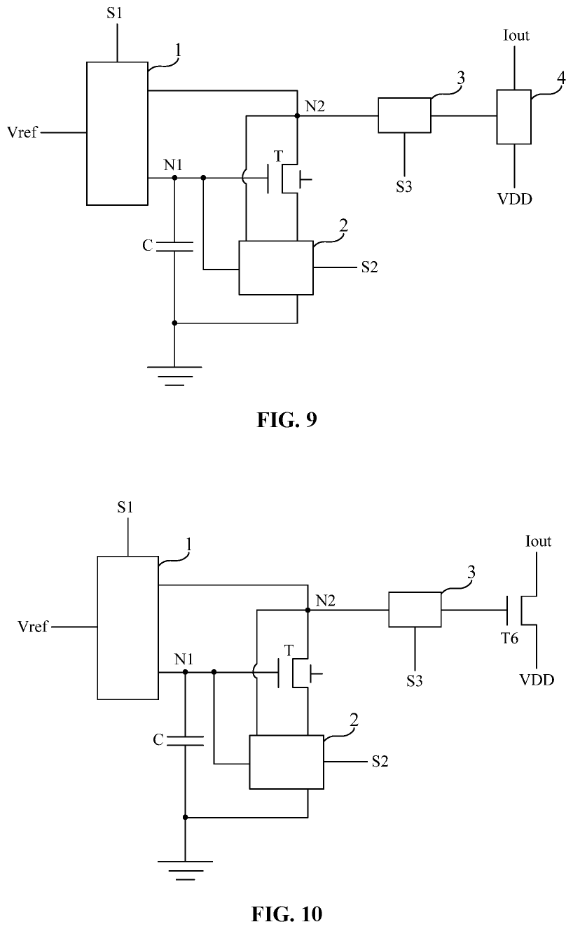

Based on the preceding embodiments, in an embodiment of the present disclosure, FIG. 7 is a schematic diagram of a circuit structure of another detection unit according to an embodiment of the present disclosure, and FIG. 8 is a structure diagram of a detection unit according to an embodiment of the present disclosure. As shown in FIGS. 7 and 8, the detection unit includes an ion-sensitive field-effect transistor T, a first transistor T1, a second transistor T2, a third transistor T3, a fourth transistor T4, a fifth transistor T5 and a storage capacitor. Both a gate of the first transistor T1 and a gate of the second transistor T2 are connected to the first scan signal S1 via a first scan signal line G1, both a first electrode of the first transistor T1 and a first electrode of the second transistor T2 are connected to the reference voltage Vref via a reference voltage line D1, a second electrode of the first transistor T1 is connected to a drain of the ion-sensitive field-effect transistor T, and a second electrode of the second transistor T2 is connected to a gate of the ion-sensitive field-effect transistor T. Both a gate of the third transistor T3 and a gate of the fourth transistor T4 are connected to a second scan signal S2 via a second scan signal line G2, a first electrode of the third transistor T3 is connected to the gate of the ion-sensitive field-effect transistor T, a second electrode of the third transistor T3 is connected to a drain of the ion-sensitive field-effect transistor T, a first electrode of the fourth transistor T4 is connected to the source of the ion-sensitive field-effect transistor T, and a second electrode of the fourth transistor T4 is connected to the ground via a ground line D2. A gate of the fifth transistor T5 is connected to the third scan signal S3 via a third scan signal line G3, a first electrode of the fifth transistor T5 is connected to the drain of the ion-sensitive field-effect transistor T, and a second electrode of the fifth transistor T5 is connected to an output signal line D3. Based on the embodiments, the first scan signal S1 controls the first transistor T1 and the second transistor T2 to turn on first, the reference voltage Vref is transmitted to the node N2 via the first transistor T1 while the reference voltage Vref is transmitted to the node N1 via the second transistor T2, the drain voltage and the gate voltage of the ion-sensitive field-effect transistor T are reset to the reference voltage Vref, the storage capacitor C is charged, and the voltage of the storage capacitor C is held at the reference voltage Vref. Then, the first scan signal S1 controls the first transistor T1 and the second transistor T2 to turn off, the second scan signal S2 controls the third transistor T3 and the fourth transistor T4 to turn on, and the third scan signal S3 controls the fifth transistor T5 to turn on. In this manner, the storage capacitor C continuously discharges, and the voltage at the node N1 is transmitted to the node N2, so that the voltage at the node N2 remains consistent with the voltage of the node N1, the threshold voltage can be output by an output switch subunit 3 via the node N2 when the voltage at the node N1 reaches the threshold voltage of the ion-sensitive field-effect transistor T and the threshold voltage is output via the output signal line D3, and the threshold voltage of the ion-sensitive field-effect transistor T can be directly read to calculate a pH value or an ion concentration of a to-be-detected solution based on the threshold voltage.

In addition, considering that a variation amount of drifting of the threshold voltage of the ion-sensitive field-effect transistor affected by the ion concentration is very small, generally tens of millivolts, it is difficult to capture the variation amount of the threshold voltage due to a limitation on signal acquisition accuracy. Therefore, amplification processing needs to be performed on the acquired detection voltage. Based on this, in an embodiment, as shown in FIG. 9, the detection unit further includes a signal amplification subunit 4, the signal amplification subunit 4 is used for amplifying the threshold voltage of the ion-sensitive field-effect transistor T output by the output switch subunit 3 into a current, and a detection current Iout is output via the signal amplification subunit 4. In this manner, the amplification processing is performed on the threshold voltage so that the detection is easier, thereby improving the accuracy of the solution detection.

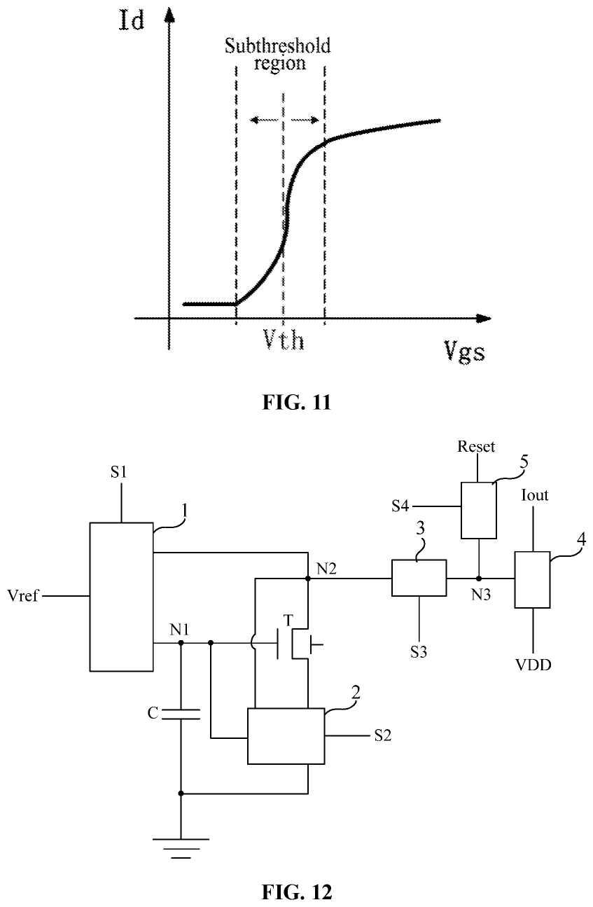

Based on the preceding embodiments, in an embodiment, as shown in FIG. 10, the signal amplification subunit includes a sixth transistor T6, a gate of the sixth transistor T6 is connected to the second terminal of the output switch subunit 3, a first electrode (for example, the drain) of the sixth transistor T6 is connected to a supply voltage VDD, and a second electrode of the sixth transistor T6 outputs the current. The second electrode of the sixth transistor T6 is connected to the ground, that is, the output signal line is connected to the ground, so that only the current in the output signal line needs to be acquired. In this manner, a gate-source voltage Vgs of the sixth transistor T6 is equal to the threshold voltage of the ion-sensitive field-effect transistor T output via the output switch subunit 3. Referring to FIG. 11, it is considered that in a subthreshold region, even if the threshold voltage varies slightly, a corresponding drain current (a source current in the present disclosure is equal to the drain current) still varies significantly. Therefore, a threshold voltage of the sixth transistor T6 is set to be the same as the reference threshold voltage of the ion-sensitive field-effect transistor T, thereby ensuring that the gate-source voltage of the sixth transistor T6 is in the subthreshold region of the sixth transistor T6 and obtaining a relatively large current. According to a curve illustrating a relationship between the gate-source voltage Vgs and the drain current Id shown in FIG. 11, the gate-source voltage corresponding to the detected current may be obtained, that is, the threshold voltage of the ion-sensitive field-effect transistor T output via the output switch subunit 3. In this manner, the variation amount of the threshold voltage is further determined according to the threshold voltage and the reference threshold voltage, and the variation amount of the pH value is obtained according to a corresponding relationship between the variation amount of the threshold voltage and the variation amount of the pH value, and finally, the pH value of the to-be-detected solution is obtained by comparing with a reference pH value. In an embodiment, a value range of the supply voltage VDD is 10 V to 20 V.

In an embodiment, as shown in FIG. 12, the detection unit further includes a second reset switch subunit 5, and the second reset switch subunit 5 is used for resetting the second terminal of the output switch subunit 3. Exemplarily, before the output switch subunit 3 is turned on, the second reset switch subunit 5 may be controlled to reset a node N3 at the second terminal of the output switch subunit 3, and then the output switch subunit 3 is controlled to turn on, the interference of an external signal can be eliminated from affecting the threshold voltage of the ion-sensitive field-effect transistor T output by the output switch subunit 3, and the accuracy of the threshold voltage can be further ensured.

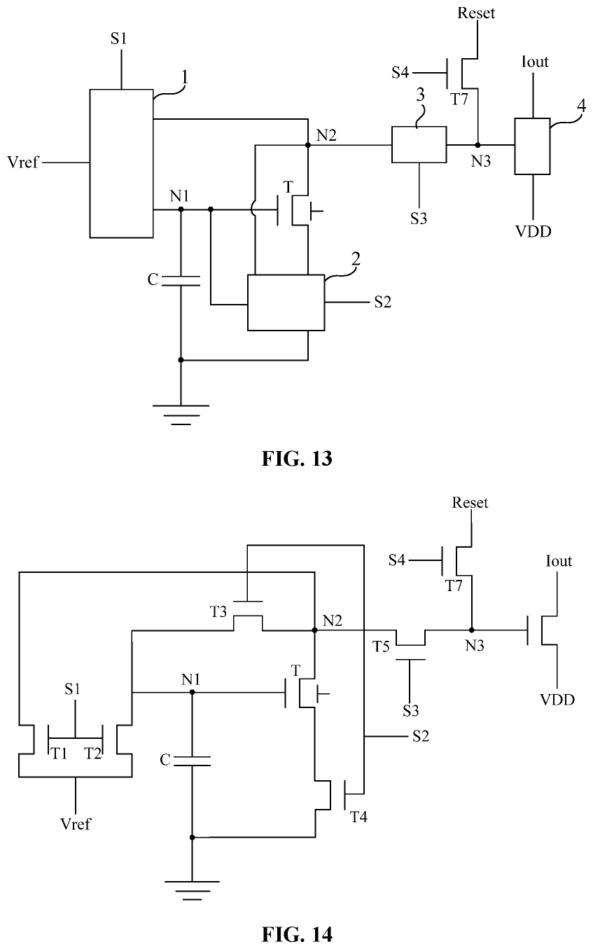

Based on the preceding embodiments, in an embodiment, as shown in FIG. 13, the second reset switch subunit includes a seventh transistor T7, a first electrode of the seventh transistor T7 is connected to a reset voltage Reset, a second electrode of the seventh transistor T7 is connected to the second terminal (the node N3) of the output switch subunit, and a gate of the seventh transistor T7 is connected to a fourth scan signal S4. In this manner, when the node N3 needs to be reset, the fourth scan signal S4 controls the seventh transistor T7 to turn on, and the node N3 is directly reset to the reset voltage Reset. In an embodiment, the reset voltage Reset is 0.

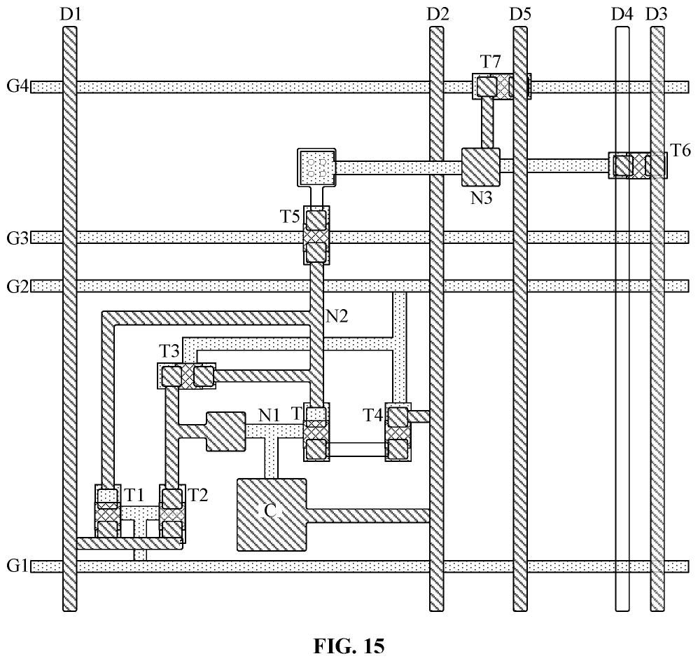

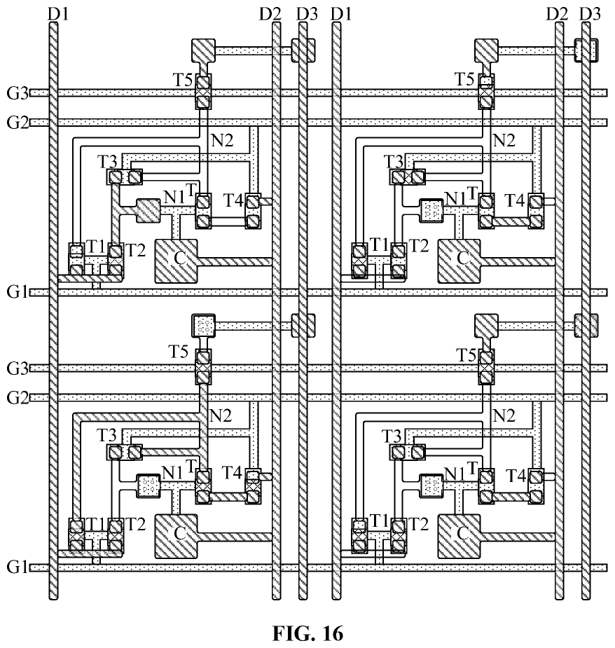

Based on the preceding embodiments, in an embodiment, as shown in FIGS. 14 and 15, the detection unit includes an ion-sensitive field-effect transistor T, a first transistor T1, a second transistor T2, a third transistor T3, a fourth transistor T4, a fifth transistor T5, a storage capacitor, a sixth transistor T6 and a seventh transistor T7. Both a gate of the first transistor T1 and a gate of the second transistor T2 are connected to a first scan signal S1 via a first scan signal line G1, both a first electrode of the first transistor T1 and a first electrode of the second transistor T2 are connected to a reference voltage Vref via a reference voltage line D1, a second electrode of the first transistor T1 is connected to a drain of the ion-sensitive field-effect transistor T, and a second electrode of the second transistor T2 is connected to a gate of the ion-sensitive field-effect transistor T. Both a gate of the third transistor T3 and a gate of the fourth transistor T4 are connected to a second scan signal S2 via a second scan signal line G2, a first electrode of the third transistor T3 is connected to the gate of the ion-sensitive field-effect transistor T, a second electrode of the third transistor T3 is connected to the drain of the ion-sensitive field-effect transistor T, a first electrode of the fourth transistor T4 is connected to a source of the ion-sensitive field-effect transistor T, and a second electrode of the fourth transistor T4 is connected to the ground via a ground line D2. A gate of the fifth transistor T5 is connected to a third scan signal S3 via a third scan signal line G3, a first electrode of the fifth transistor T5 is connected to the drain of the ion-sensitive field-effect transistor T, and a second electrode of the fifth transistor T5 is connected to a gate of the sixth transistor T6, a first electrode of the sixth transistor T6 is connected to a supply voltage VDD via a supply voltage line D4, a second electrode of the sixth transistor T6 is connected to an output signal line D3, and the current Tout is output by the output signal line D3. A first electrode of the seventh transistor T7 is connected to a reset voltage Reset via a reset voltage line D5, a second electrode of the seventh transistor T7 is connected to the node N3, and a gate of the seventh transistor T7 is connected to a fourth scan signal S4 via a fourth scan signal line G4. A working principle of the detection unit provided in the embodiment is not described in detail. Reference may be made to the preceding embodiments for details.

In some embodiments, referring to FIG. 1, the solution detection circuit includes a plurality of detection units 10 arranged in an array along rows and columns, and the solution detection circuit further includes a plurality of first scan signal lines G1, a plurality of second scan signal lines G2 and a plurality of third scan signal lines G3 arranged in a column direction and extending in a row direction, and a plurality of reference voltage lines D1, a plurality of ground lines D2 and a plurality of output signal lines D3 arranged in the row direction and extending in the column direction. Control terminals of first reset switch subunits in the same row of detection units 10 are connected to the same first scan signal line G1, control terminals of synchronous buck switch subunits in the same row of detection units 10 are connected to the same second scan signal line G2, and control terminals of output switch subunits in the same row of detection units 10 are connected to the same third scan signal line G3; first reset switch subunits in the same column of detection units 10 are connected to the same reference voltage line D1, synchronous buck switch subunits and second plates of storage capacitors in the same column of detection units 10 are connected to the same ground line D2, and second terminals of output switch subunits in the same column of detection units 10 are connected to the same output signal line D3.

In this manner, progressive scanning is performed on the plurality of detection units 10 in the solution detection circuit so that detection signals (detection voltages or detection currents) detected by one row of detection units 10 can be output at a time and detection signals detected by all detection units 10 can be output within one frame, thereby quickly detecting the ion concentrations at a plurality of sites and significantly improving the detection efficiency of multiple samples.

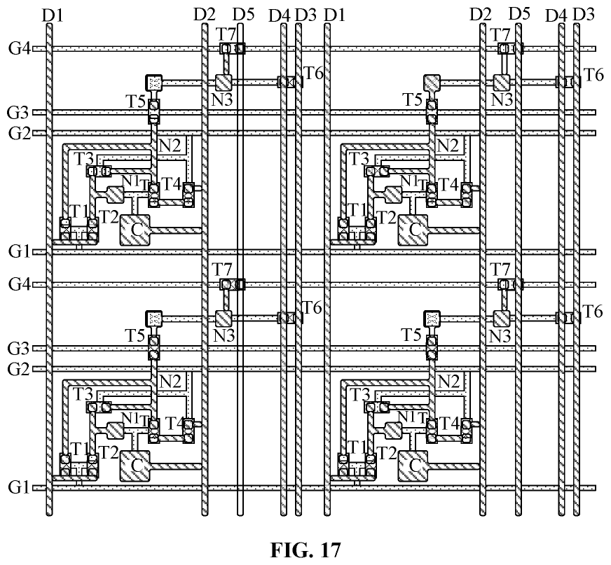

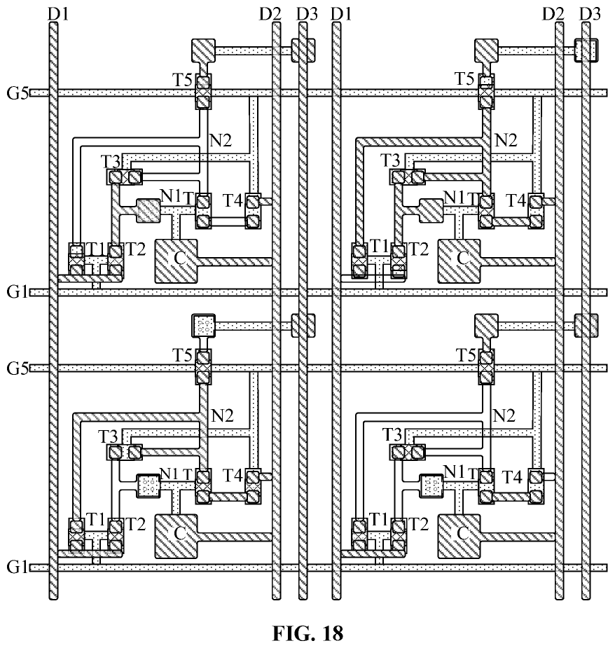

In an embodiment, each of the first reset switch subunit, the synchronous buck switch subunit and the output switch subunit is composed of a thin-film transistor, a gate of each thin-film transistor, the gate of the ion-sensitive field-effect transistor, the first plate of the storage capacitor, the plurality of first scan signal lines, the plurality of second scan signal lines and the plurality of third scan signal lines are located on the same layer and prepared with the same material, and a source and a drain of each thin-film transistor, the source and the drain of the ion-sensitive field-effect transistor, the second plate of the storage capacitor, the plurality of reference voltage lines, the plurality of ground lines and the plurality of output signal lines are located on the same layer and prepared with the same material. In this manner, some films of each device may be separately prepared through the same process, thereby saving the process cost. FIG. 16 illustrates an array structure of a solution detection circuit corresponding to the structure of the detection unit in FIG. 8, and FIG. 17 illustrates an array structure of a solution detection circuit corresponding to the structure of the detection unit in FIG. 15. Reference may be made to the preceding embodiments for working principles and driving methods of the above two solution detection circuits, which are not repeated here.

In an embodiment, referring to FIG. 16, any column of detection units is located between a corresponding reference voltage line D1 and a ground line D2, and an output signal line D3 is located on a side of the ground line D2 facing away from the corresponding detection units. The reason is that the ground line D2 needs to be connected to the fourth transistor T4 and the storage capacitor C while the output signal line D3 only needs to be connected to the fifth transistor T5. In this manner, only one cross-bridge structure where the output signal line D3 is connected to the fifth transistor T5 needs to be disposed, thereby simplifying wiring.

In an embodiment, the second scan signal line and the third scan signal line that correspond to the same row of detection units are connected to each other. Considering that the second scan signal and the third scan signal may be the same (amplitudes are the same and vary synchronously), the second scan signal line and the third scan signal line that correspond to the same row of detection units are connected to each other so that the second scan signal and the third scan signal can be provided by the same signal source, thereby reducing a pin of a driver chip.

In an embodiment, as shown in FIG. 18, the second scan signal line and the third scan signal line that correspond to the same row of detection units are the same signal line G5. Similarly, considering that the second scan signal and the third scan signal may be the same and the use of the same signal line does not cause an interference to the third transistor T3, the fourth transistor and the fifth transistor T5, the second scan signal line and the third scan signal line that correspond to the same row of detection units are set to the same signal line, thereby reducing the wiring and further simplifying the circuit structure.

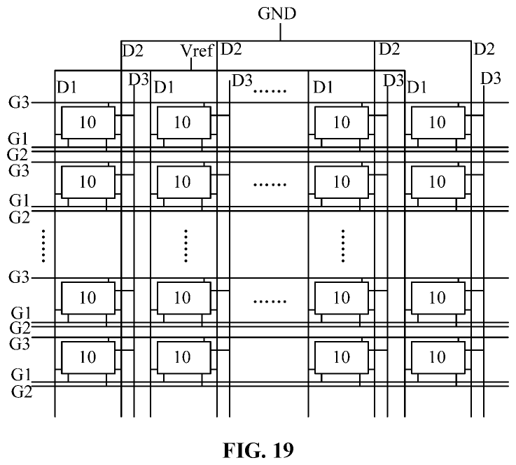

In some embodiments, as shown in FIG. 19, the plurality of reference voltage lines D1 are connected to one another, and the plurality of ground lines D2 are connected to one another. Since reference voltages provided to all the detection units 10 may be the same, the plurality of reference voltage lines D1 are connected to one another so that the plurality of reference voltage lines D1 are connected to the same reference voltage source, thereby significantly reducing the reference voltage source or reducing the pins of the driver chip. Similarly, connecting the plurality of ground lines D2 to one another can achieve the same effect.

In some embodiments, the plurality of detection units arranged in the array along rows and columns constitute a detection unit array, input terminals of the plurality of first scan signal lines, input terminals of the plurality of second scan signal lines and input terminals of the plurality of third scan signal lines are located on a first side of the detection unit array, input terminals of the plurality of reference voltage lines, input terminals of the plurality of ground lines and output terminals of the plurality of output signal lines are located on a second side of the detection unit array, and the first side and the second side are adjacent sides or the same side of the detection unit array.

Exemplarily, the first side and the second side are adjacent sides of the detection unit array, for example, the input terminals of the plurality of first scan signal lines, the input terminals of the plurality of second scan signal lines and the input terminals of the plurality of third scan signal lines are located on a left side of the detection unit array, and the input terminals of the plurality of reference voltage lines, the input terminals of the plurality of ground lines and the output terminals of the plurality of output signal lines are located on an upper side of the detection unit array, so that the pixel structure can be more compact and the pixel dimension may be 350 um*350 um. In addition, the first side and the second side are the same side of the detection unit array, for example, the input terminals of the plurality of first scan signal lines, the input terminals of the plurality of second scan signal lines and the input terminals of the plurality of third scan signal lines are located on the left side of the detection unit array, and the input terminals of the plurality of reference voltage lines, the input terminals of the plurality of ground lines and the output terminals of the plurality of output signal lines are led out from the upper side of the detection unit array and separately led to the left side of the detection unit array through line changing. In this manner, driving can be performed by one driver chip, thereby reducing the number of driver chips.

Embodiments of the present disclosure further provide a solution detection apparatus. The solution detection apparatus includes the solution detection circuit provided in any one of the embodiments of the present disclosure. The solution detection apparatus and the solution detection circuit have the same functions and beneficial effects, which are not repeated here.

In addition, embodiments of the present disclosure further provide a method for driving the solution detection circuit provided in the embodiments of the present disclosure. The method for driving the solution detection circuit includes the steps described below.

In S110, the first reset switch subunit is turned on to reset a gate voltage and a drain voltage of the ion-sensitive field-effect transistor to the reference voltage and charge the storage capacitor.

In S120, the first reset switch subunit is turned off, and the synchronous buck switch subunit is turned on, so that the gate voltage and the drain voltage of the ion-sensitive field-effect transistor drop to the threshold voltage of the ion-sensitive field-effect transistor.

In S130, the output switch subunit is turned on to output the threshold voltage through the output switch subunit.

In some embodiments, the solution detection circuit further includes a signal amplification subunit, and after the output switch subunit is turned on, the method further includes the step described below.

The signal amplification subunit is turned on to amplify the threshold voltage into a current.

In some embodiments, the solution detection circuit further includes a second reset switch subunit, and before the output switch subunit is turned on, the method further includes the step described below.

The second reset switch subunit is turned on to reset the second terminal of the output switch subunit.

In addition, embodiments of the present disclosure further provide a solution detection method applied to the solution detection circuit provided in any one of the embodiments of the present disclosure. The solution detection method includes the steps described below.

In S210, the first reset switch subunit is turned on to reset a gate voltage and a drain voltage of the ion-sensitive field-effect transistor to the reference voltage and charge the storage capacitor.

In S220, the first reset switch subunit is turned off, and the synchronous buck switch subunit is turned on, so that the gate voltage and the drain voltage of the ion-sensitive field-effect transistor drop to the threshold voltage of the ion-sensitive field-effect transistor.

In S230, the output switch subunit is turned on to output the threshold voltage through the output switch subunit.

In S240, a pH value or an ion concentration of a to-be-detected solution is determined according to the threshold voltage.

It is to be noted that herein, relationship terms such as “first” and “second” are used merely for distinguishing one entity or operation from another, and do not necessarily require or imply any such actual relationship or order between these entities or operations. Furthermore, the term “comprising”, “including” or any other variant thereof is intended to encompass a non-exclusive inclusion so that a process, method, article or device including a series of elements not only includes the expressly listed elements but also includes other elements that are not expressly listed or are inherent to such a process, method, article or device. In the absence of more restrictions, the elements defined by the statement “including a . . . ” do not exclude the presence of additional identical elements in the process, method, article or device that includes the elements.

The preceding are merely example embodiments of the present disclosure to enable those skilled in the art to understand or implement the present disclosure. Various modifications to these embodiments will be apparent to those skilled in the art, and the general principles defined herein may be implemented in other embodiments without departing from the spirit or scope of the disclosure. Therefore, the present disclosure is not intended to be limited to the embodiments shown herein but is to accord with the widest scope consistent with the principles and novel features disclosed herein.

What is claimed is:

1. A solution detection circuit, comprising at least one detection unit, wherein each of the at least one detection unit comprises an ion-sensitive field-effect transistor, a first reset switch subunit, a synchronous buck switch subunit, a storage capacitor and an output switch subunit;
wherein a first terminal of the first reset switch subunit is connected to a reference voltage, a second terminal of the first reset switch subunit is connected to a gate of the ion-sensitive field-effect transistor, and a third terminal of the first reset switch subunit is connected to a drain of the ion-sensitive field-effect transistor; a first terminal of the synchronous buck switch subunit is connected to the gate of the ion-sensitive field-effect transistor, a second terminal of the synchronous buck switch subunit is connected to the drain of the ion-sensitive field-effect transistor, a third terminal of the synchronous buck switch subunit is connected to a source of the ion-sensitive field-effect transistor, and a fourth terminal of the synchronous buck switch subunit is connected to a ground; a first plate of the storage capacitor is connected to the gate of the ion-sensitive field-effect transistor, and a second plate of the storage capacitor is connected to the ground; a first terminal of the output switch subunit is connected to the drain of the ion-sensitive field-effect transistor; a control terminal of the first reset switch subunit is connected to a first scan signal, a control terminal of the synchronous buck switch subunit is connected to a second scan signal, and a control terminal of the output switch subunit is connected to a third scan signal.

2. The solution detection circuit according to claim 1, wherein the first reset switch subunit comprises a first transistor and a second transistor, wherein both a gate of the first transistor and a gate of the second transistor are connected to the first scan signal, both a first electrode of the first transistor and a first electrode of the second transistor are connected to the reference voltage, a second electrode of the first transistor is connected to the drain of the ion-sensitive field-effect transistor, and a second electrode of the second transistor is connected to the gate of the ion-sensitive field-effect transistor.

3. The solution detection circuit according to claim 1, wherein the synchronous buck switch subunit comprises a third transistor and a fourth transistor, wherein both a gate of the third transistor and a gate of the fourth transistor are connected to the second scan signal, a first electrode of the third transistor is connected to the gate of the ion-sensitive field-effect transistor, a second electrode of the third transistor is connected to the drain of the ion-sensitive field-effect transistor, a first electrode of the fourth transistor is connected to the source of the ion-sensitive field-effect transistor, and a second electrode of the fourth transistor is connected to the ground.

4. The solution detection circuit according to claim 1, wherein the output switch subunit comprises a fifth transistor, wherein a first electrode of the fifth transistor is connected to the drain of the ion-sensitive field-effect transistor, and a gate of the fifth transistor is connected to the third scan signal.

5. The solution detection circuit according to claim 1, wherein each of the at least one detection unit further comprises a signal amplification subunit, wherein the signal amplification subunit is configured to amplify a threshold voltage of the ion-sensitive field-effect transistor output by the output switch subunit into a current.

6. The solution detection circuit according to claim 5, wherein the signal amplification subunit comprises a sixth transistor, wherein a gate of the sixth transistor is connected to a second terminal of the output switch subunit, a first electrode of the sixth transistor is connected to a supply voltage, and a second electrode of the sixth transistor outputs the current.

7. The solution detection circuit according to claim 1, wherein each of the at least one detection unit further comprises a second reset switch subunit, wherein the second reset switch subunit is configured to reset a second terminal of the output switch subunit.

8. The solution detection circuit according to claim 7, wherein the second reset switch subunit comprises a seventh transistor, wherein a first electrode of the seventh transistor is connected to a reset voltage, a second electrode of the seventh transistor is connected to the second terminal of the output switch subunit, and a gate of the seventh transistor is connected to a fourth scan signal.

9. The solution detection circuit according to claim 1, wherein the solution detection circuit comprises a plurality of detection units arranged in an array along rows and columns, and the solution detection circuit further comprises a plurality of first scan signal lines, a plurality of second scan signal lines, a plurality of third scan signal lines, a plurality of reference voltage lines, a plurality of ground lines and a plurality of output signal lines, wherein the plurality of first scan signal lines, the plurality of second scan signal lines and the plurality of third scan signal lines are arranged in a column direction and extending in a row direction, and the plurality of reference voltage lines, the plurality of ground lines and the plurality of output signal lines are arranged in the row direction and extending in the column direction;
wherein control terminals of first reset switch subunits in a same row of detection units among the plurality of detection units are connected to a same first scan signal line in the plurality of first scan signal lines, control terminals of synchronous buck switch subunits in a same row of detection units among the plurality of detection units are connected to a same second scan signal line in the plurality of second scan signal lines, and control terminals of output switch subunits in a same row of detection units among the plurality of detection units are connected to a same third scan signal line in the plurality of third scan signal lines; and
first reset switch subunits in a same column of detection units among the plurality of detection units are connected to a same reference voltage line in the plurality of reference voltage lines, synchronous buck switch subunits and second plates of storage capacitors in a same column of detection units among the plurality of detection units are connected to a same ground line in the plurality of ground lines, and second terminals of output switch subunits in a same column of detection units among the plurality of detection units are connected to a same output signal line in the plurality of output signal lines.

10. The solution detection circuit according to claim 9, wherein each of the first reset switch subunit, the synchronous buck switch subunit and the output switch subunit is composed of a thin-film transistor;
a gate of the thin-film transistor, the gate of the ion-sensitive field-effect transistor, the first plate of the storage capacitor, the plurality of first scan signal lines, the plurality of second scan signal lines and the plurality of third scan signal lines are located on a same layer and prepared with a same material; and
a source and a drain of the thin-film transistor, the source of the ion-sensitive field-effect transistor, the drain of the ion-sensitive field-effect transistor, the second plate of the storage capacitor, the plurality of reference voltage lines, the plurality of ground lines and the plurality of output signal lines are located on a same layer and prepared with a same material.

11. The solution detection circuit according to claim 9, wherein a column of detection units among the plurality of detection units are located between a reference voltage line and a ground line that correspond to the column of detection units, and an output signal line is located on a side of the ground line facing away from the column of detection units.

12. The solution detection circuit according to claim 9, wherein a second scan signal line in the plurality of second scan signal lines and a third scan signal line in the plurality of third scan signal lines that correspond to a same row of detection units among the plurality of detection units are connected to each other.

13. The solution detection circuit according to claim 9, wherein a second scan signal line in the plurality of second scan signal lines and a third scan signal line in the plurality of third scan signal lines that correspond to a same row of detection units among the plurality of detection units are a same signal line.

14. The solution detection circuit according to claim 9, wherein the plurality of reference voltage lines are connected to one another, and the plurality of ground lines are connected to one another.

15. The solution detection circuit according to claim 9, wherein the plurality of detection units arranged in the array along rows and columns constitute a detection unit array, input terminals of the plurality of first scan signal lines, input terminals of the plurality of second scan signal lines and input terminals of the plurality of third scan signal lines are located on a first side of the detection unit array, and input terminals of the plurality of reference voltage lines, input terminals of the plurality of ground lines and output terminals of the plurality of output signal lines are located on a second side of the detection unit array, wherein the first side and the second side are adjacent sides or a same side of the detection unit array.

16. A solution detection apparatus, comprising the solution detection circuit according to claim 1.

17. A method for driving a solution detection circuit, wherein the solution detection circuit comprises at least one detection unit, each of the at least one detection unit comprises an ion-sensitive field-effect transistor, a first reset switch subunit, a synchronous buck switch subunit, a storage capacitor and an output switch subunit; wherein a first terminal of the first reset switch subunit is connected to a reference voltage, a second terminal of the first reset switch subunit is connected to a gate of the ion-sensitive field-effect transistor, and a third terminal of the first reset switch subunit is connected to a drain of the ion-sensitive field-effect transistor; a first terminal of the synchronous buck switch subunit is connected to the gate of the ion-sensitive field-effect transistor, a second terminal of the synchronous buck switch subunit is connected to the drain of the ion-sensitive field-effect transistor, a third terminal of the synchronous buck switch subunit is connected to a source of the ion-sensitive field-effect transistor, and a fourth terminal of the synchronous buck switch subunit is connected to a ground; a first plate of the storage capacitor is connected to the gate of the ion-sensitive field-effect transistor, and a second plate of the storage capacitor is connected to the ground; a first terminal of the output switch subunit is connected to the drain of the ion-sensitive field-effect transistor; a control terminal of the first reset switch subunit is connected to a first scan signal, a control terminal of the synchronous buck switch subunit is connected to a second scan signal, and a control terminal of the output switch subunit is connected to a third scan signal;
wherein the method for driving the solution detection circuit comprises:
turning on the first reset switch subunit to reset a gate voltage and a drain voltage of the ion-sensitive field-effect transistor to the reference voltage and charge the storage capacitor;
turning off the first reset switch subunit, and turning on the synchronous buck switch subunit, so that the gate voltage and the drain voltage of the ion-sensitive field-effect transistor drop to a threshold voltage of the ion-sensitive field-effect transistor; and
turning on the output switch subunit to output the threshold voltage through the output switch subunit.

18. The method according to claim 17, wherein the solution detection circuit further comprises a signal amplification subunit, and after the output switch subunit is turned on, the method further comprises:
turning on the signal amplification subunit to amplify the threshold voltage into a current.

19. The method according to claim 18, wherein the solution detection circuit further comprises a second reset switch subunit, and before the output switch subunit is turned on, the method further comprises:
turning on the second reset switch subunit to reset a second terminal of the output switch subunit.

20. A solution detection method, applied to a solution detection circuit, wherein the solution detection circuit comprises at least one detection unit, wherein each of the at least one detection unit comprises an ion-sensitive field-effect transistor, a first reset switch subunit, a synchronous buck switch subunit, a storage capacitor and an output switch subunit; wherein a first terminal of the first reset switch subunit is connected to a reference voltage, a second terminal of the first reset switch subunit is connected to a gate of the ion-sensitive field-effect transistor, and a third terminal of the first reset switch subunit is connected to a drain of the ion-sensitive field-effect transistor; a first terminal of the synchronous buck switch subunit is connected to the gate of the ion-sensitive field-effect transistor, a second terminal of the synchronous buck switch subunit is connected to the drain of the ion-sensitive field-effect transistor, a third terminal of the synchronous buck switch subunit is connected to a source of the ion-sensitive field-effect transistor, and a fourth terminal of the synchronous buck switch subunit is connected to a ground; a first plate of the storage capacitor is connected to the gate of the ion-sensitive field-effect transistor, and a second plate of the storage capacitor is connected to the ground; a first terminal of the output switch subunit is connected to the drain of the ion-sensitive field-effect transistor; a control terminal of the first reset switch subunit is connected to a first scan signal, a control terminal of the synchronous buck switch subunit is connected to a second scan signal, and a control terminal of the output switch subunit is connected to a third scan signal; and
wherein the method comprises:
turning on the first reset switch subunit to reset a gate voltage and a drain voltage of the ion-sensitive field-effect transistor to the reference voltage and charge the storage capacitor;
turning off the first reset switch subunit, and turning on the synchronous buck switch subunit, so that the gate voltage and the drain voltage of the ion-sensitive field-effect transistor drop to a threshold voltage of the ion-sensitive field-effect transistor;
turning on the output switch subunit to output the threshold voltage through the output switch subunit; and
determining a pH value or an ion concentration of a to-be-detected solution according to the threshold voltage.
